(19) United States
(12) Patent Application Publication
(10) Pub. No.: US 2008/0297735 A1
(43) Pub. Date: Dec. 4, 2008

(54) LAMP DRIVING METHOD

(75) Inventors: Mei-Ling Chen, Hsinchu (TW); S-Wei Chen, Hsinchu (TW); Chao-Shun Chen, Hsinchu (TW); Hung-Cheng Lung, Hsinchu (TW); Chun-Fa Hsu, Hsinchu (TW); Cheng-Shun Liao, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 11/851,883

(22) Filed: Sep. 7, 2007

(30) Foreign Application Priority Data
May 31, 2007 (TW) 96119569

(51) Int. Cl. H05B 41/36; G03B 21/20

(52) U.S. Cl. 353/85; 315/291

(57) ABSTRACT

A lamp driving method for a projection apparatus is provided. The projection apparatus has a light valve and a lamp. The lamp driving method includes adjusting a brightness of the lamp to different values according to multiple states of the light valve. The lamp driving method improves the energy efficiency of the projection apparatus.

### CROSS-REFERENCE TO RELATED APPLICATION

This application claims the priority benefit of Taiwan application serial no. 96119569, filed May 31, 2007. All disclosure of the Taiwan application is incorporated herein by reference.

### BACKGROUND OF THE INVENTION

1. Field of the Invention

The present invention relates to a lamp driving method. More particularly, the present invention relates to a lamp driving method for a projection apparatus.

2. Description of Related Art

Referring to FIG. 1A, a conventional projection apparatus 100 includes a lamp 110, a liquid crystal on silicon (LCOS) panel 120, a projection lens 130, a color wheel 140 and a polarization beam splitting prism 150. The lamp 110 provides an illumination beam 112. The color wheel 140 having a red filter 142r, a green filter 142g and a blue filter 142b is disposed on a transmission path of the illumination beam 112. The color wheel 140 converts the illumination beam 112 into red light 112r, green light 112g and blue light 112b in sequence. The polarization beam splitting prism 150 is disposed on the transmission path of the illumination beam 112 for reflecting the part of the illumination beam 112 having an S polarization direction to the LCOS panel 120. The LCOS panel 120 converts the illumination beam 112 into an image beam 122 having a P polarization direction, and reflects the image beam 122 to the projection lens 130.

Referring to FIGS. 1A and 1B, the referential number 50 in FIG. 1B represents a light spot formed by the illumination beam 112 projected on the color wheel 140. The color wheel 140 includes a plurality of filters 142 with different colors. During the time period from time T1 at which the boundary 144 between two adjacent filters 142 passes through the left end of the horizontal line 52a of the light spot 50 to time T2 at which the boundary 144 passes through the right end of the horizontal line 52a, the horizontal line 52a falls on both two filters 142 having different colors to generate light with two different colors. Therefore, during the time period from time T1 to time T2, the LCOS panel 120 is in a turn-off state, which causes a decrease of image brightness and lower energy efficiency of the projection apparatus 100. Referring to FIG. 1C, similarly, the same problem occurs during the time period from time T3 at which the boundary 144 passes through the right end of the horizontal line 52b of the light spot 50 to time T2 at which the boundary 144 passes through the left end of the horizontal line 52b of the light spot 50.

Referring to FIGS. 1A and 2, in a conventional lamp driving method, currents having the same absolute value (i.e. the current values equals to I₀ or −I₀) are applied to the lamp 110 to light the lamp 110 up regardless of the LCOS panel 120 being in the turned-on state or the turned-off state. In particular, the lamp 110 provides the illumination beam 112 having the same brightness regardless of the LCOS panel 120 being in the turned-on state or the turned-off state. However, the beam provided by the lamp 110 cannot be utilized by the projection apparatus 100 when the LCOS panel 120 is turned off (for example, during the time period from time d₁ to time d₂). Therefore, it causes a waste of power to apply a current to the lamp 110 during the time period when the LCOS panel 120 is turned off, and the energy efficiency of the projection apparatus decreases accordingly.

Moreover, in a projection apparatus using a ferroelectric liquid crystal panel, since the sum of the driving voltage of the ferroelectric liquid crystal in each cycle time (e.g. 100 millisecond to 1 second) is required to be zero to maintain direct current (DC) balance, the LCOS panel is alternately turned on and off. In other words, within each cycle time, the LCOS panel is turned on in a half of the cycle time, and turned off in the other half of the cycle time. Accordingly, it is a waste of power that a current is applied to the lamp during the time period when the LCOS panel is turned off, and the energy efficiency of the projection apparatus decreases.

### SUMMARY OF THE INVENTION

The present invention is directed to a lamp driving method to improve energy efficiency of a projection apparatus using the lamp driving method.

Additional advantages of the present invention will be set forth in the technical features disclosed by the present invention.

An embodiment of the present invention provides a lamp driving method for a projection apparatus. The projection apparatus includes a light valve and a lamp. The lamp driving method includes the following steps. A brightness of the lamp is adjusted to a first brightness when the light valve is in a first state. The brightness of the lamp is adjusted to a second brightness when the light valve is in a second state. The second brightness is different from the first brightness.

The lamp driving method includes adjusting a brightness of the lamp to different values according to multiple states of the light valve. For example, the brightness of the lamp may be decreased when the light valve is turned off, and the brightness of the lamp may be increased when the light valve is turned on. Therefore, the energy efficiency of a projection apparatus using the lamp driving method of the present invention is effectively improved.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A is a structural diagram of a conventional projection apparatus.

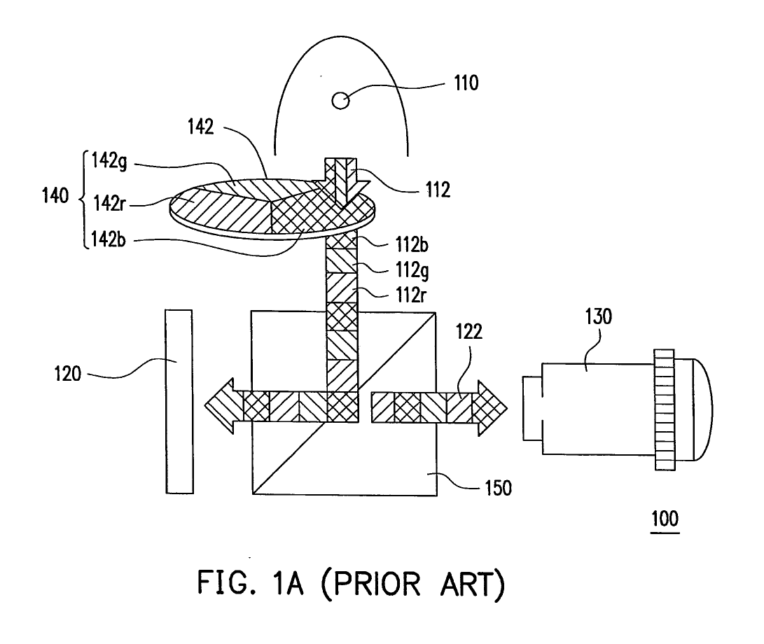

FIGS. 1B and 1C illustrates a light spot formed by the illumination beam in FIG. 1A projected on the color wheel.

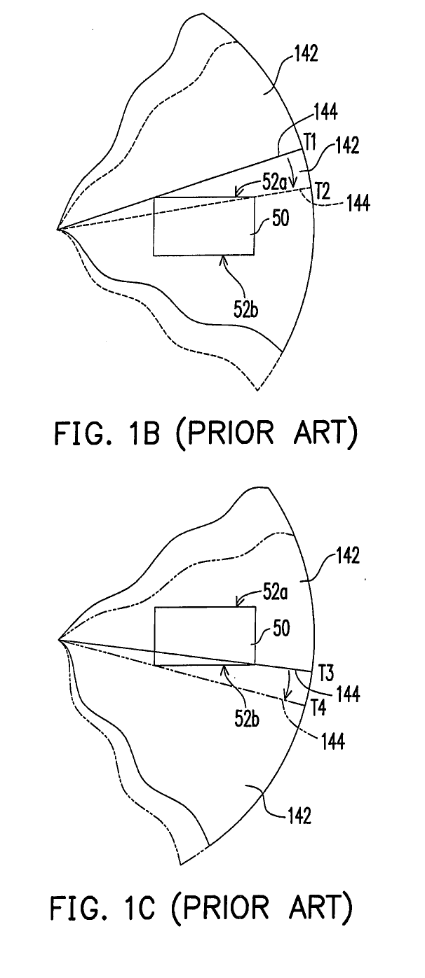

FIG. 2 is a diagram of a driving waveform of a conventional lamp driving method.

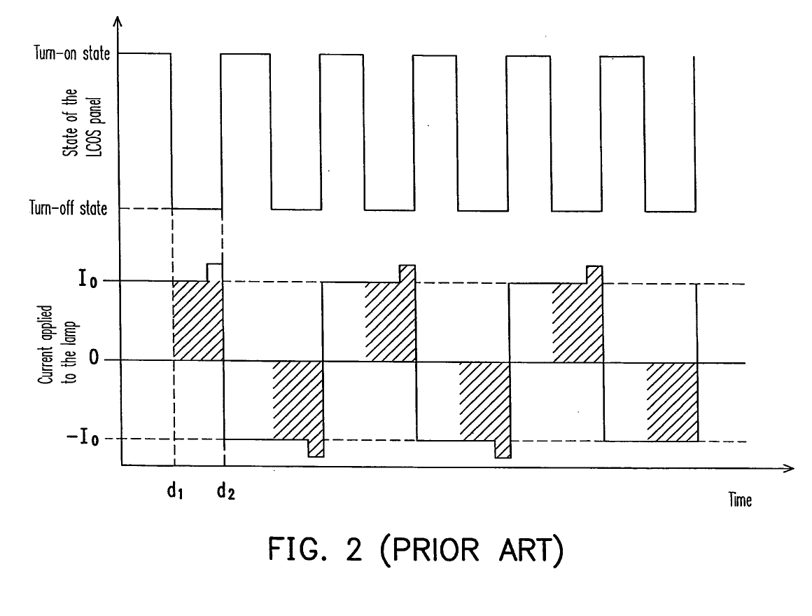

FIG. 3 is a diagram of a driving waveform of a lamp driving method according to a first embodiment of the present invention.

FIG. 4 is a diagram of a driving waveform of a lamp driving method according to a second embodiment of the present invention.

FIG. 5 is a diagram of a driving waveform of a lamp driving method according to a third embodiment of the present invention.

FIG. 6 is a diagram of a driving waveform of a lamp driving method according to a fourth embodiment of the present invention.

### DESCRIPTION OF EMBODIMENTS

It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “coupled,” and variations thereof herein are used broadly and encompass direct and indirect connections and couplings.

### The First Embodiment

The lamp driving method according to the embodiment of the present embodiment is applied to a projection apparatus having a light valve and a lamp. The lamp driving method includes adjusting the brightness of the lamp to different values according to multiple states of the light valve. Moreover, the projection apparatus further has a color wheel, and the light valve is liquid crystal on silicon (LCOS) panel, a transmissible liquid crystal panel or a digital micro-mirror device (DMD).

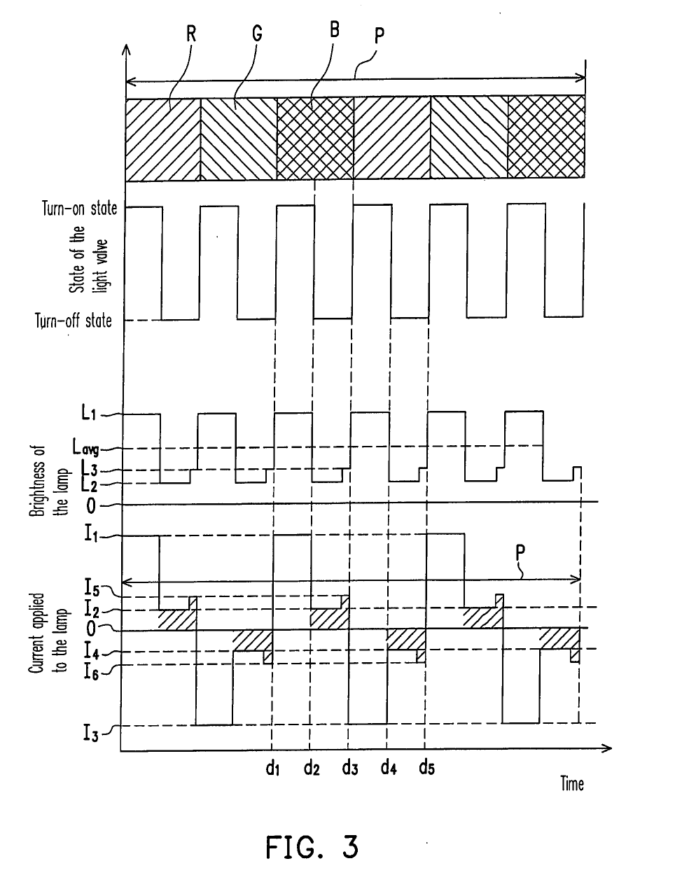

FIG. 3 is a diagram of a driving waveform of the lamp driving method according to a first embodiment of the present invention. The horizontal axis in FIG. 3 represents time, and the vertical axis represents colors of the light provided by the lamp and passing through the color wheel, states of the light valve, a brightness of the lamp, and current values applied to the lamp. Referring to FIG. 3, in this embodiment, the light valve has a turn-on state and a turn-off state, and the light valve is alternately turned on and off. The lamp driving method includes the following steps. The brightness of the lamp is adjusted to a first brightness L₁ when the light valve is turned on. The brightness of the lamp is adjusted to a second brightness L₂ when the light valve is turned off. The second brightness L₂ is less than the first brightness L₁. Moreover, the brightness corresponding to the average output power of the lamp is an average brightness L_{avg}, and L₂<L_{avg}<L₁. In this embodiment, the brightness of the lamp is the same each time when the light valve is tuned on, and the brightness of the lamp is the same each time the light valve is turned off.

In this embodiment, a first positive current I₁, a second positive current I₂, a first negative current I₃ and a second negative current I₄ may be alternately applied to the lamp by using an alternating current (AC) signal to change the brightness of the lamp. The current applied to the lamp may be the first positive current I₁ or the first negative current I₃, when the light valve is turned on, and the current applied to the lamp may be the second positive current I₂ or the second negative current I₄ when the light valve is turned off. Moreover, the first positive current I₁ is greater than the second positive current I₂, and an absolute value of the first negative current I₃ is greater than an absolute value of the second negative current I₄. For example, during the time period from time d₁ to time d₂, the light valve is turned on, and the current applied to the lamp is the first positive current I₁, so as to adjust the brightness of the lamp to the first brightness L₁. During the time period from time d₂ to time d₃, the light valve is turned off, and the current applied to the lamp is the second positive current I₂, so as to adjust that the brightness of the lamp to the second brightness L₂. During the time period from time d₃ to time d₄, the light valve is turned on, and the current applied to the lamp is the first negative current I₃, so as to adjust the brightness of the lamp to the first brightness L₁. During the time period from time d₄ to time d₅, the light valve is turned off, and the current applied to the lamp is the second negative current I₄, so as to adjust the brightness of the lamp to the second brightness L₂. In addition, the first positive current I₁ may be equal to the absolute value of the first negative current I₃, and the second positive current I₂ may be equal to the absolute value of the second negative current I₄.

As described above, since the light beam of the lamp is not utilized during the period when the light valve is turned off, it effectively saves the energy to decrease the brightness of the lamp during the period when the light valve is turned off. Moreover, the brightness of the lamp may be increased during the period when the light valve is turned on to ensure the first brightness L₁ being greater than the average brightness L_{avg}, so as to effectively improve the brightness of the projection apparatus. In addition, compared with the conventional techniques, supposing that the energy consumption is the same, more energy is utilized when the light valve is turned on in the lamp driving method in this embodiment, such that the lamp provides light with a higher brightness, so as to improve the energy efficiency of the projection apparatus.

When the current applied to the lamp changes from a positive current to a negative current or changes from a negative current to a positive current, the current value is zero at a certain moment, which likely causes a flicker phenomenon perceived by human eyes. To solve this problem, at this moment that the current applied to the lamp changes from a positive current to a negative current or changes from a negative current to a positive current, the absolute value of the current is slightly increased to slightly increase the brightness of the lamp, such that the flicker phenomenon of the lamp is not easily perceived by human eyes due to the visual persistence effect. Therefore, in this embodiment, before the current applied to the lamp changes from the second positive current I₂ to the first negative current I₃, the current applied to the lamp may be increased. Similarly, before the current applied to the lamp changes from the second negative current I₄ to the first positive current I₁, the absolute value of the current applied to the lamp may be increased. For example, a current I₅ is applied to the lamp at the moment before time d₃, so as to adjust the brightness of the lamp to a brightness L₃. Similarly, a current I₆ is applied to the lamp at the moment before time d₅, so as to adjust the brightness of the lamp to a brightness L₃. The current I₅ is slightly greater than the second positive current I₂, and the current I₆ is slightly less than the second negative current I₄.

In this embodiment, the time needed for the light valve being turned on 2N times and turned off 2N times may be defined as a period P, and the sum of the current applied to the lamp within each period P is substantially zero. The value of N may be related to the number of the colors of the filters of the color wheel and the N is a positive integer. In particular, it is assumed that the color wheel includes red filter, green filter and blue filter, and then the value of N is equal to 3. Moreover, in each period P, the light provided by the lamp is changed to red light R, green light G and blue light B in sequence after passing through the color wheel. The light valve may be turned on 6 times within each period P to process the red light R, green light G, blue light B, red light R, green light G and the blue light B in sequence. It should be noted that the present invention has no limitation about colors and arrangement sequence of the filters of the color wheel.

### The Second Embodiment

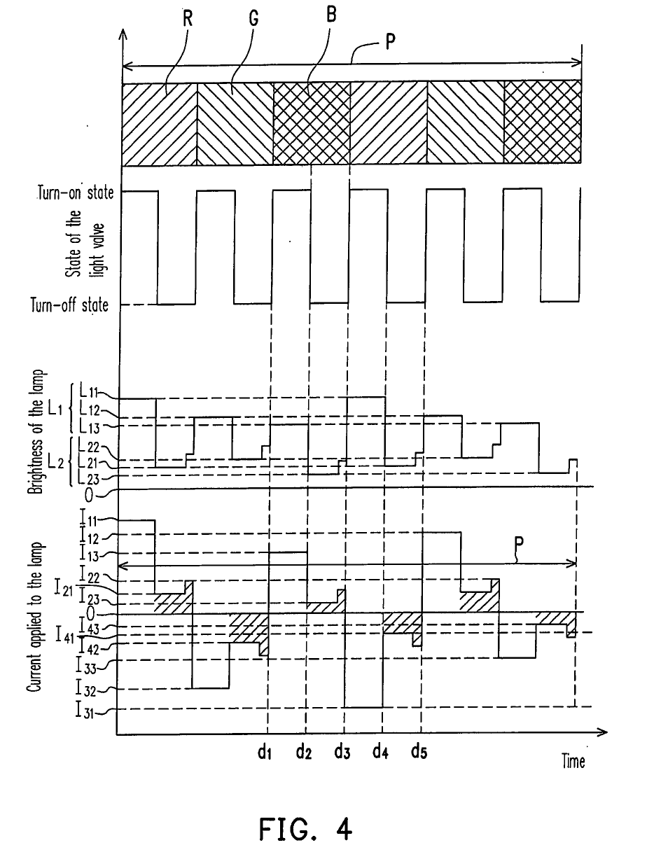

FIG. 4 is a diagram of a driving waveform of a lamp driving method according to a second embodiment of the present invention. Referring to FIG. 4, the lamp driving method of this embodiment is similar to that of the first embodiment, and the differences between the two are described below. In the lamp driving method in this embodiment, the first brightness L₁ of the lamp may change each time when the light valve is turned on, and the second brightness L₂ of the lamp may change each time when the light valve is turned off. In particular, the first brightness L₁ may have three variations, i.e. brightness L₁₁, brightness L₁₂ and brightness L₁₃. The second brightness L₂ may have three variations, i.e. brightness L₂₁, brightness L₂₂ and brightness L₂₃. The light intensity of the red light R, green light G and blue light B projected on the light valve are adjusted by adjusting the brightness of the lamp, so as to adjust the white balance or other color parameters of the display images projected by the projection apparatus.

In this embodiment, the current I₁ and the current I₃₁ may be applied to the lamp, such that the brightness of the lamp is adjusted to the brightness L₁₁. The current I₃₂ and the current I₁₂ may be applied to the lamp, such that the brightness of the lamp is adjusted to the brightness L₁₂. The current I₁₃ and the current I₃₃ may be applied to the lamp, such that the brightness of the lamp is adjusted to the brightness L₁₃. The current I₂₁ and the current I₄₁ may be applied to the lamp, such that the brightness of the lamp is adjusted to the brightness L₂₁. The current I₄₂ and the current I₂₂ may be applied to the lamp, such that the brightness of the lamp is adjusted to the brightness L₂₂. The current I₂₃ and the current I₄₃ may be applied to the lamp, such that the lamp is adjusted to the brightness L₂₃.

### The Third Embodiment

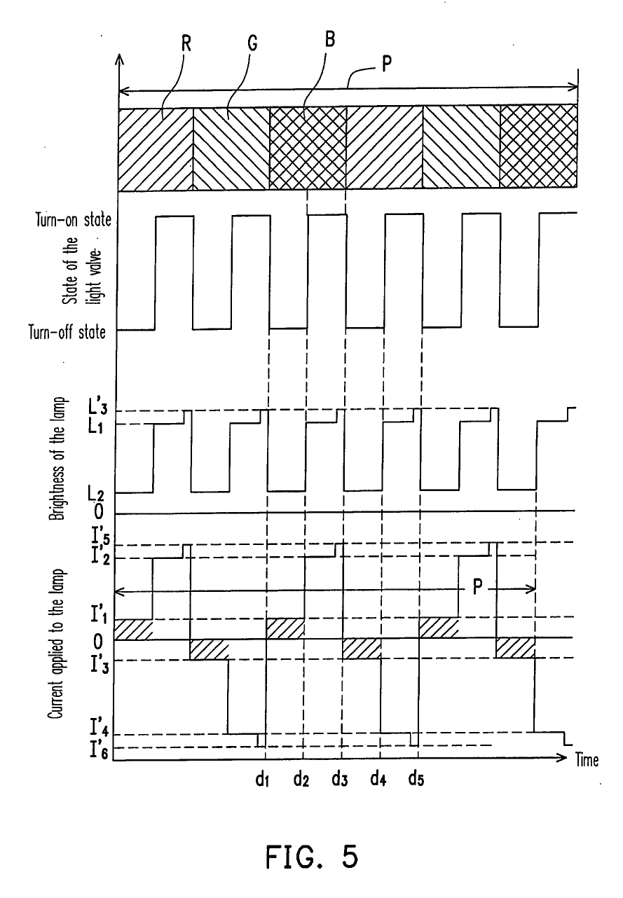

FIG. 5 is a diagram of a driving waveform of a lamp driving method according to a third embodiment of the present invention. Referring to FIG. 5, the lamp driving method of this embodiment is similar to that of the first embodiment, and the differences between the two are described below. In this embodiment, the light valve is turned off first and then turned on within each period P. The first positive current I₁′ applied to the lamp when the light valve is turned off is less than the second positive current I₂′ applied to the lamp when the light valve is turned on, and the absolute value of the first negative current I₃′ applied to the lamp when the light valve is turned off is less than the absolute value of the second negative current I₄′ applied to the lamp when the light valve is turned on. The current applied to the lamp may be the first positive current I₁′ or the first negative current I₃′, and the current applied to the lamp may be the second positive current I₂′ or the second negative current I₄′. Moreover, the first positive current I₁′ is less than the second positive current I₂′, and the absolute value of the first negative current I₃′ is less than that the absolute value of the second negative current I₄′.

In addition, the current applied to the lamp may be increased before the current changes from a positive current to a negative current, and the absolute value of the current applied to the lamp may be increased before the current applied to the lamp changes from a negative current to a positive current. In particular, the current applied to the lamp may be increased before it changes from the second positive current I₂′ to the first negative current I₃′. Similarly, the absolute value of the current applied to the lamp may be increased before the current applied to the lamp changes from the second negative current I₄′ to the first positive current I₅′. For example, the current applied to the lamp may be increased to be a current I₅′ at the moment before time d₃, such that the brightness of the lamp is adjusted to brightness L₃′. The current applied to the lamp may be decreased to be a current I₆′ at the moment before time d₅, such that the brightness of the lamp is adjusted to brightness L₃′. The current I₅′ is slightly greater than the second positive current I₂′, and the current I₆′ is slightly less than the second negative current I₄′.

### The Fourth Embodiment

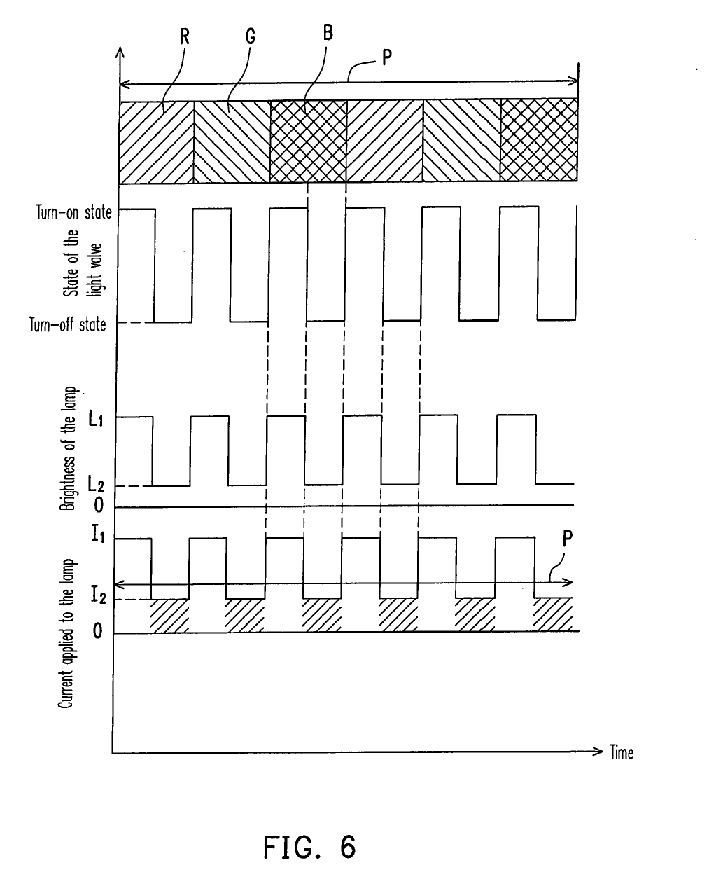

FIG. 6 is a diagram of a driving waveform of the lamp driving method according to a fourth embodiment of the present invention. Referring to FIG. 6, the lamp driving method in this embodiment is similar to that of the first embodiment except that a direct current (DC) signal is applied for driving the lamp in this embodiment. In particular, a DC signal is used for applying a first current I₁ and a second current I₂ less than the first current I₁ alternately to the lamp in this embodiment. When the light valve is turned on, the first current I₁ is applied to the lamp, such that the brightness of the lamp is adjusted to a first brightness L₁. When the light valve is turned off, the second current I₂ is applied to the lamp, such that the brightness of the lamp is adjusted to a second brightness L₂. The first brightness L₁ is greater than the second brightness L₂.

In summary, the lamp driving method of the present invention includes adjusting the brightness of the lamp to different values according to multiple states of the light valve. For example, the lamp brightness may be decreased when the light valve is turned off, and the lamp brightness may be increased when the light valve is turned on, such that the energy consumption of the lamp during the period when the light valve is turned off is reduced. Meanwhile, more energy can be utilized during the period when the light valve is turned on, so as to improve the brightness of the lamp. Therefore, the energy efficiency of a projection apparatus using the lamp driving method of the present invention is effectively improved.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A lamp driving method, for a projection apparatus having a light valve and a lamp, comprising:
adjusting a brightness of the lamp to a first brightness when the light valve is in a first state; and
adjusting the brightness of the lamp to a second brightness when the light valve is in a second state, wherein the second brightness is different from the first brightness.

2. The lamp driving method as claimed in claim 1, wherein the first state of the light valve is a turn-on state, the second state of the light valve is a turn-off state, and the second brightness is less than the first brightness.

3. The lamp driving method as claimed in claim 2, comprising adjusting the brightness of the lamp to be the same each time when the light valve is turned on, and adjusting the brightness of the lamp to be the same each time when the light valve is turned off.

4. The lamp driving method as claimed in claim 2, comprising changing the first brightness of the lamp each time when the light valve is turned on, and changing the second brightness of the lamp each time when the light valve is turned off.

5. The lamp driving method as claimed in claim 2, comprising using a direct current signal to alternately apply a first current and a second current less than the first current to the lamp to change the brightness of the lamp, wherein the first current is applied to the lamp when the light valve is turned on, and the second current is applied to the lamp when the light valve is turned off.

6. The lamp driving method as claimed in claim 2, comprising using an alternating current signal to alternately apply a first positive current, a second positive current, a first negative current and a second negative current to the lamp to change the brightness of the lamp.

7. The lamp driving method as claimed in claim 6, wherein a current applied to the lamp is the first positive current or the first negative current when the light valve is turned on, a current applied to the lamp is the second positive current or the second negative current when the light valve is turned off, and the first positive current is greater than the second positive current, and an absolute value of the first negative current is greater than an absolute value of the second negative current.

8. The lamp driving method as claimed in claim 7, wherein the current applied to the lamp is increased before the current applied to the lamp changes from the second positive current to the first negative current, and an absolute value of the current applied to the lamp is increased before the current applied to the lamp changes from the second negative current to the first positive current.

9. The lamp driving method as claimed in claim 6, wherein a current applied to the lamp is the first positive current or the first negative current when the light valve is turned off, and a current applied to the lamp is the second positive current or the second negative current when the light valve is turned on, and the first positive current is less than the second positive current, and an absolute value of the first negative current is less than an absolute of the second negative current.

10. The lamp driving method as claimed in claim 9, wherein the current applied to the lamp is increased before the current applied to the lamp changes from the second positive current to the first negative current, and an absolute value of the current applied to the lamp is increased before the current applied to the lamp changes from the second negative current to the first positive current.

11. The lamp driving method as claimed in claim 6, wherein a time needed for the light valve being turned on 2N times and turned off 2N times is defined as a period, a sum of a current applied to the lamp within each period is substantially zero, and N is a positive integer.

12. The lamp driving method as claimed in claim 11, wherein N is equal to 3.
